(19) United States
(12) Patent Application Publication
(10) Pub. No.: US 2004/0028476 A1
(43) Pub. Date: Feb. 12, 2004

(54) System and method for automatically drilling and backreaming a horizontal bore underground

(75) Inventors: David R. Payne, Perry, OK (US); Gerald A. Stangl, Stillwater, OK (US); Norman E. Stevens JR., Perry, OK (US); Michael F. Gard, Perry, OK (US)

Correspondence Address: MCKINNEY & STRINGER, P.C., 101 N. ROBINSON, OKLAHOMA CITY, OK, 73102, US

(73) Assignee: The Charles Machine Works, Inc., Perry, OK

(21) Appl. No.: 10/617,975

(22) Filed: Jul. 12, 2003

Related U.S. Application Data
(63) Continuation of application No. 09/481,351, filed on Jan. 12, 2000.

(51) Int. Cl. F16L 1/00; E02F 5/10

(52) U.S. Cl. 405/184

(57) ABSTRACT

A system and method for automatically drilling and backreaming a horizontal borehole underground. The system includes a horizontal drilling machine and a machine control system for operating the drilling machine. The machine control system has sensors and control circuits for monitoring and automatically controlling the functions of the drilling machine. The machine control system manages the power consumption of the drilling machine, the fluid dispensed during drilling and backreaming, the lengthening and shortening of the drill string, the tracking and recording of progress along a selected bore path, and the guiding of the downhole tool along the selected bore path. In a drilling operation the method involves identifying a selected bore path and automatically guiding the downhole tool along the selected bore path. In a backreaming operation the method involves connecting a backreamer and a utility line to the drill string and automatically pulling the utility line back through the borehole.

### CROSS REFERENCE TO RELATED APPLICATION

This application is a continuation of U.S. application Ser. No. 09/481,351 filed Jan. 12, 2000.

### FIELD OF THE INVENTION

The present invention relates to the field of drilling horizontal underground boreholes, and in particular to using an automated drilling system to drill a horizontal underground borehole.

### SUMMARY OF THE INVENTION

The present invention comprises an horizontal drilling system for use in drilling or backreaming a pilot borehole. In a preferred embodiment, the horizontal drilling system comprises a horizontal drilling machine and a machine control system adapted to operate the drilling machine. The horizontal drilling machine comprises a drill string having a first end and a second end, a drive system operatively connectable to the first end of the drill string and adapted to advance the drill string through the earth, and a downhole tool connectable to the second end of the drill string. The machine control system comprises a plurality of sensors, each positioned to sense data relative to at least one of a plurality of parameters defining the operation of the drilling machine, and a main control circuit adapted to receive data from the plurality of sensors and to automatically operate the boring machine in response to the data.

In another embodiment, the invention comprises a method for drilling a pilot borehole through the earth. The method comprises the steps of identifying a selected bore path having a beginning point and an ending point, automatically advancing a downhole tool along the selected bore path, automatically determining the position of the downhole tool relative to the selected bore path, and automatically guiding the downhole tool in response to the determined downhole tool position and the selected bore path.

In yet another aspect, the invention comprises a method for installing a utility line in a borehole. The method comprises drilling a pilot borehole and automatically backreaming the pilot borehole while installing a utility line.

In another embodiment, the invention comprises a horizontal drilling system comprising a horizontal drilling machine and a machine control system adapted to automatically operate the drilling machine. The horizontal drilling machine comprises a drill string having a first end and a second end, a drive system operatively connectable to the first end of the drill string and adapted to advance the drill string through the earth, and a downhole tool connectable to the second end of the drill string. The machine control system is adapted to receive data signals from a remote location, the data signals being indicative of the depth and geographic location of the downhole tool. The machine control system operates the drilling machine in response to the data signals received.

In a further embodiment, the invention comprises a method for advancing an underground tool from a first point to a second point in a surface to surface horizontal drilling operation. The method comprises the steps of identifying a selected bore path from the first point to the second point and guiding the underground tool along the selected bore path by automatically changing the direction of the underground tool.

In yet another aspect, the invention comprises a horizontal drilling system comprising a horizontal drilling machine having a plurality of automated functions and a machine control system. The horizontal drilling machine comprises a drill string having a first end and a second end, a drive system operatively connectable to the first end of the drill string and adapted to axially move the drill string through the earth, and an underground tool connectable to the second end of the drill string. The machine control system comprises a plurality of sensors and a main control circuit. The sensors are each adapted to detect data relating to at least one parameter characteristic of the operation or environment of the drilling machine. The main control circuit is adapted to receive data from the plurality of sensors and to automatically operate the automated functions of the drilling machine in response to this data.

In another embodiment, the invention comprises a method for using a horizontal drilling machine having a plurality of automated functions. The machine comprises a drill string to which an underground tool is attached. The method comprises the steps of selecting a path along which the underground tool is to be used and axially advancing the drill string so as to move the underground tool along at least a portion of the selected path, while automatically operating the automated functions of the drilling machine.

In another aspect, the invention comprises a horizontal drilling system comprising a horizontal drilling machine having a plurality of automated functions and a machine control system. The drilling machine comprises a drill string having a first end and a second end, a drive system operatively connectable to the first end of the drill string and adapted to advance the drill string through the earth, and a downhole tool connectable to the second end of the drill string. The drilling machine further comprises a pipe handling assembly adapted to extend and reduce the length of the drill string and a fluid dispensing assembly adapted to deliver fluid to the downhole tool. The machine control system comprises a plurality of sensors and a main control circuit. Each of the sensors is adapted to detect data relating to at least one parameter characteristic of the operation or environment of the drilling machine. The main control circuit is adapted to receive data from the plurality of sensors and to automatically operate at least two of the automated functions of the drilling machine in response to this data. The automated functions of the drilling machine are selected from the group comprising a pipe handling function, a power management function, a guidance control function, a fluid control function, and a tracking function.

### BRIEF DESCRIPTION OF THE DRAWINGS

FIG. 1 is a side view of a horizontal drilling system with a drilling machine and machine control circuit in accordance with the present invention.

FIG. 2 is a right frontal perspective view of a carriage and spindle, a fluid dispensing system, hydraulic and thrust circuits and a pipe handling assembly for use with a horizontal drilling machine.

FIG. 3 is a block diagram of an automatic drilling system having a drilling machine and a machine control circuit in accordance with the present invention.

FIG. 4 is a plan view of a selected bore path.

FIG. 5 is a side view of the selected bore path shown in FIG. 4.

FIG. 6 is a block diagram of an embodiment of a machine control circuit for use with an automatic drilling system.

FIG. 7 is a block diagram of a circuit for controlling the power system of an automatic drilling system.

FIG. 8 is a flow diagram of a version of software for a Power Management routine for the power management control circuit of FIG. 7.

FIG. 9 is a block diagram of a circuit for controlling the fluid dispensing system of an automatic drilling system.

FIG. 10 is a flow diagram of a version of software for a Fluid Control routine for the fluid control circuit of FIG. 9.

FIG. 11 is a block diagram of a circuit for a pipe handling system of an automatic drilling system.

FIG. 12 is a block diagram of a circuit for a tracking system of an automatic drilling system.

FIG. 13 is a block diagram of a circuit for a guidance control system of an automatic drilling system.

FIG. 14 is a flow diagram of a version of software for an Automatic Guidance routine for the guidance control circuit of FIG. 13.

FIG. 15 is a flow diagram of a version of software for a Compare to Plan routine for the guidance control circuit of FIG. 13.

FIG. 16 is a flow diagram of a version of software for a Straight Bore Cycle routine for the guidance control circuit of FIG. 13.

FIG. 17 is a flow diagram of a version of software for a Direction Control routine for the guidance control circuit of FIG. 13.

FIG. 18 is a flow diagram of a version of software for a Roll Stop Cycle routine for the guidance control circuit of FIG. 13.

FIG. 19 is a flow diagram of a version of software for a Rock Cycle routine for the guidance control circuit of FIG. 13.

FIG. 20 is a flow diagram of a version of software for an Automatic Backream routine for the main control circuit.

### BACKGROUND OF THE INVENTION

Horizontal boring machines are used to install utility services or other products underground. Horizontal boring eliminates surface disruption along the length of the project, except at the entry and exit points, and reduces the likelihood of damaging previously buried products. Skilled and experienced crews have greatly increased the efficiency and accuracy of boring operations. However, there is a continuing need for more fully automated boring machines which reduce the need for operator intervention and thereby increase the efficiency of boring underground.

The boring operation consists of using a boring machine to advance a drill string through the earth along a selected path. The selected path is generally mapped in advance of the boring operation and ideally will be calculated based on a variety of parameters such as job site topography, estimated entry and exit points, location of known existing utility lines and easements, soil types, and equipment capabilities. A selected path generally is depicted with a plan view and a side view. Skilled operators then follow the selected path using conventional steering and tracking techniques.

The boring machine generally comprises a frame, an anchoring system, a drive system mounted on the frame and connected to the exposed end of the drill string, and a boring tool connected to the downhole end of the drill string. The anchoring system secures the boring machine to the ground and prevents the machine from moving as it is used. The drive system provides thrust and rotation needed to advance the drill string and the boring tool through the earth. The drive system generally has a motor or power source to rotate the drill string and a separate motor or power source to push and pull the drill string. An operator can advance the drill string in a generally straight line by simultaneously rotating and pushing the drill string through the earth. To control the direction of the borehole, the operator uses conventional steering techniques, such as a slant-faced drill bit. With the slant-faced bit, the direction of the borehole is changed by orienting the drill bit to point in the desired new direction. The drill string is then pushed through the earth without rotation, so that the slant-face causes the drill string to veer in the desired direction.

The drill string is generally comprised of a plurality of drill pipe sections joined together at threaded connections. As the boring operation proceeds, the drill string is lengthened by repeatedly adding pipe sections to the drill string. Each time a pipe section is added to the drill string, the pipe section being added first is aligned with the drill string and the threaded joints are lubricated to ensure proper connections. Then the connections between the drive system, the pipe section, and the drill string are secured. The process is the same each time a pipe section is added to the drill string.

The precise location of the boring tool during the boring operation may be monitored with conventional tracking techniques. Using one such technique, a beacon or transmitter located at the boring tool generates a signal detected by an above ground tracker or receiver. The tracker uses signal strength to determine location and depth of the boring tool and obtains information attached to the signal to indicate the orientation and other status of the boring tool and the transmitter. The boring machine operator then compares this location information to the selected bore path to determine if the direction of the boring tool needs to be changed to compensate for deviation or to begin an intended direction change. The process is repeated until the bore is completed.

When the boring operation is completed, the drill string is pulled back through the borehole, generally with the utility line or product to be installed underground connected to the end of the drill string. Many times, the original borehole must be enlarged to accommodate the product being installed. The enlarging of the borehole is accomplished by adding a backreaming tool between the end of the drill string and the product being pulled through the borehole. During this backreaming operation, the operator must monitor and control the pullback rate and force so the product is not damaged during installation. The operator also interrupts pullback to remove pipe sections as the length of the drill string is reduced.

Currently, crews of skilled operators and assisting personnel are required to initiate, control, and monitor many of the underlying functions of the boring machine. The present invention provides advantages over previously used boring machines because it automates the basic functions of the boring machine and also automatically controls the overall operation of each of those basic functions.

### DETAILED DESCRIPTION OF THE PREFERRED EMBODIMENTS

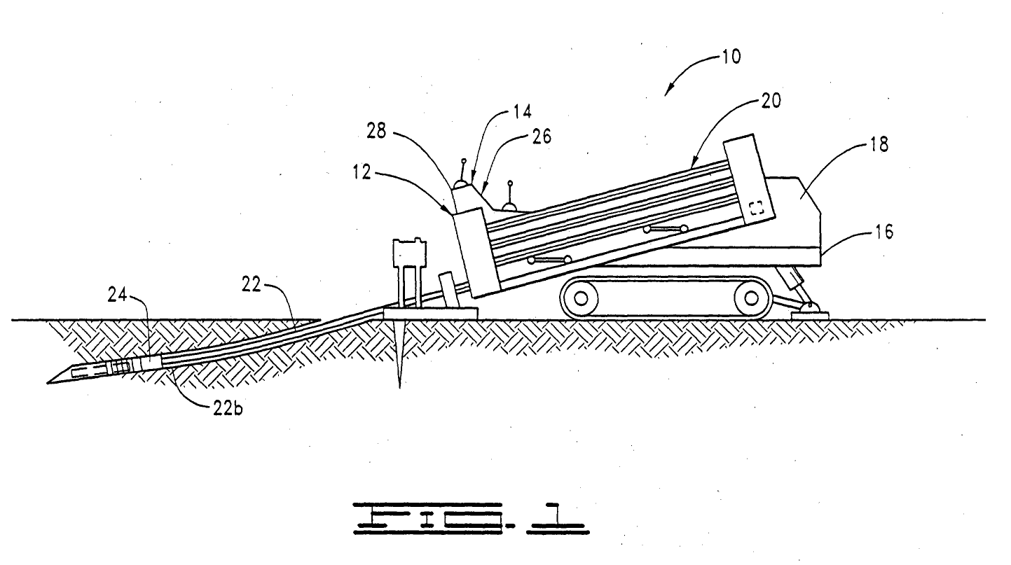

Turning now to the drawings in general and FIG. 1 in particular, there is shown therein a horizontal drilling system in accordance with the present invention. The drilling system, designated by reference numeral 10, generally comprises a drilling machine 12 and a machine control system 14. The machine control system 14 interfaces with the various components (to be described hereafter) of the drilling machine 12, automatically operating and coordinating the operations of the components during drilling and backreaming operations. As used herein, the terms drilling and boring are intended to be used interchangeably, and are to mean the process of creating a borehole.

Also as used herein, automatic operation is intended to refer to operations that can be accomplished without operator intervention and within certain predetermined tolerances. For example, electrical circuits and switches or computer processors may be used to automatically operate components of the drilling machine 12. During this automatic operation, the machine control system 14 obtains, monitors, and communicates data representative of the operations of the drilling machine 12, and operates the drilling machine in response to these data. In the preferred embodiment, an operator is required only to start the drilling system 10 and intervene when an operation is complete or when the system is forced to operate out of its tolerance range. However, the drilling system's 10 use is also contemplated where the operator may wish to intervene and manually operate one or more of the drilling machine's 12 functions, with the remaining plurality of automated functions used to assist in the operation of the machine.

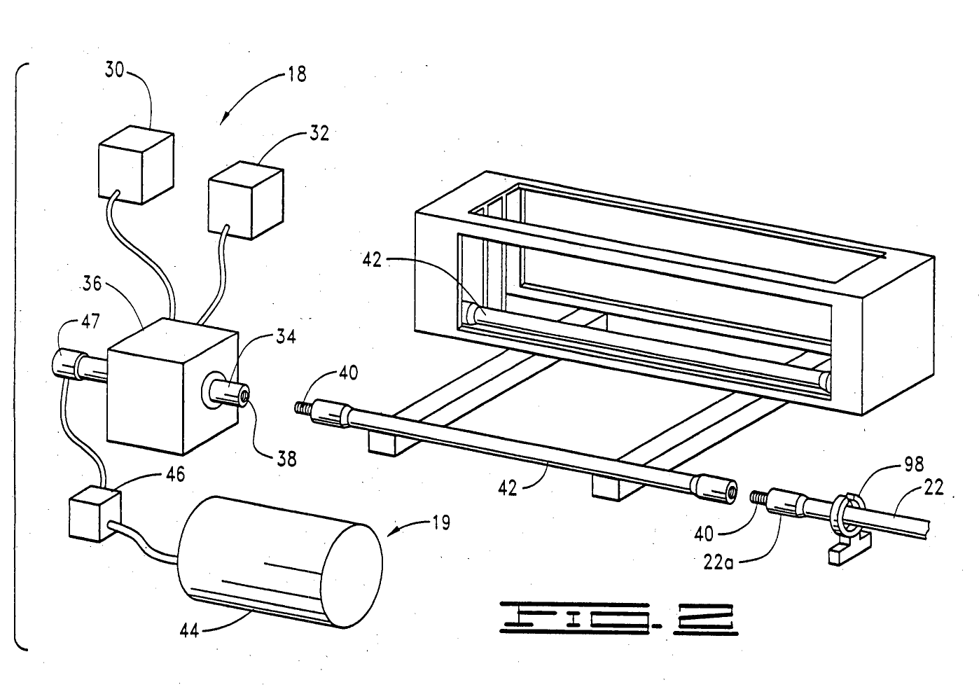

The drilling machine 12 generally comprises a frame 16, a drive system 18 supported on the frame, a fluid dispensing system 19 (shown in FIG. 2), a pipe handling system 20 supported on the frame, a drill string 22 having a first exposed end 22a (see FIG. 2) coupled to the drive system and a second downhole end 22b generally located underground, and an underground or downhole tool 24. As used herein, downhole tool 24 is intended to refer to any tool connected to the downhole end 22b of the drill string 22 and suitable for a particular purpose. For example, a drilling tool may be used for creating the borehole during a drilling operation and a backreaming tool may be used for enlarging the borehole during a backreaming operation.

The drilling machine 12 also comprises a power system (not shown) for generating and providing power to the components of the drilling machine. In the preferred embodiment, the power system comprises an engine and a plurality of hydraulic pumps, valves, and plumbing that supply power to the various components of the drilling machine 12. However, the invention contemplates the use of any systems suitable for powering the components of the drilling machine 12. For example, electric or combustion powered equipment may be used for the engine and the plurality of sources supplying power to the components of the drilling machine 12. In an alternative embodiment, power sources such as fuel cells can be used to generate power locally for any of the various components of the drilling machine 12.

The drilling machine 12 further comprises an operator's console 26 from which the machine can be monitored and operated manually. The operator's console 26 generally contains a control panel 28 having a display and machine function control mechanisms, such as joysticks, levers, switches, and buttons. The display on the control panel 28 includes a graphic display and a plurality of signaling devices, such as gauges, lights, and audible devices, to communicate the status of the automatic operations to the operator. Each or any of the underlying functions of the drilling machine 12 can be manually controlled using the machine function control mechanisms on the control panel 28.

With reference to FIG. 2, the drive system 18 preferably comprises separate hydraulic pumps or motors 30 and 32 for rotating and axially moving the drill string 22. As with other components of the drilling machine 12, an engine (not shown) supplies power needed to operate the hydraulic pumps 30 and 32 powering rotation and axial movement. The hydraulic pump 30 is operatively connected to a rotatable spindle 34. The hydraulic pump 32 is operatively connected to a movable carriage 36 that can be advanced or retracted. As used herein, axial movement will be understood to include advancing, or thrusting, and retracting, or pulling back. Reference to the term pullback is made during the backreaming operation and is analogous to the use of thrust for the drilling operation; the distinction necessary because during drilling the drill string 22 is pushed or thrust through the earth, while during backreaming the drill string is pulled back through the borehole. Whether thrusting or pulling back, axial movement of the carriage 36 will in turn cause the spindle 34 and the drill string 22 to be similarly thrust forward or pulled back.

The spindle 34 is mounted on the carriage 36 and usually comprises an internally threaded spindle pipe joint 38 for connection to an externally threaded end of a pipe joint 40 on the exposed end 22a of the drill string 22. The drill string 22 of the preferred embodiment is formed of a plurality of individual pipe sections 42 connected together at threaded pipe joints 40. However, the invention would be equally applicable to a drilling system 10 having other kinds of drill strings, such as a drill string in the form of a continuously fed pipe or a drill string made up of pipe sections secured together in a manner other than with threaded pipe joints.

Each pipe section 42 of the preferred embodiment comprises one end being a threaded male end and the opposite end of the same pipe section being a threaded female end. As used herein, a pipe joint 40 can be either of the male or female threaded ends of a pipe section 42. As designated herein, the reference numeral 42 will refer to individual pipe sections 42 and the reference numeral 22 will refer to the drill string 22 in the earth, where it is understood that the drill string comprises at least one pipe section.

The operations of making up and breaking out the connections between the spindle 34 and the end of the drill string 22, between the spindle 34 and an individual pipe section 42, or between the pipe sections comprising the drill string, involve careful coordination between the rotation and thrust of the spindle. Whenever a connection is made or broken, the rotation and axial movement of the spindle 34 must be coordinated to meet the threaded pitch of the pipe joints 40 and the spindle pipe joint 38 so that the threads of the joints are not damaged.

With continued reference to FIG. 2, the fluid dispensing system 19, generally operative while the drill string is rotating and thrusting or pulling back, supplies drilling fluid (or mud) to the drill string 22 during the drilling and backreaming operations. The fluid dispensing system 19 preferably comprises a fluid reservoir 44 and a hydraulic pump 46 to pump the fluid to the drill string 22. The fluid is pumped to a water swivel 47 on the carriage 36. From the water swivel 47, the fluid is transferred through the drill string 22. A variety of types and mixtures of drilling fluid are possible, having applicability to different drilling conditions. Additionally, the invention contemplates the use of other substances, such as air, foam, or other chemicals, to serve the purpose of the fluid in the preferred embodiment.

The pipe handling system 20 is used to extend the length of the drill string 22 as the drill string is advanced through the earth. As mentioned earlier, the drill string 22 might be comprised of a single, continuously fed pipe long enough to complete a bore. In such a case, the pipe handling system 20 would operate to ensure the pipe is properly fed into or removed from the borehole. In the preferred embodiment, the pipe handling system 20 adds and removes threaded pipe sections 42 to and from the drill string 22 in make-up and break-out operations. Preferred embodiments for suitable pipe handling systems are described in U.S. patent application Ser. No. 09/146,123, filed Sep. 2, 1998, entitled System and Method for Automatically. Controlling a Pipe Handling System for a Horizontal Boring Machine, the contents of which are incorporated herein by reference.

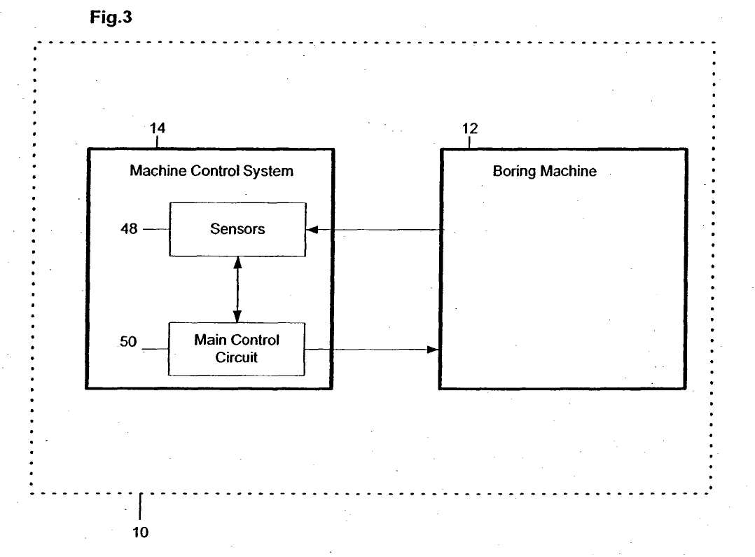

As shown in FIG. 3, the machine control system 14 coordinates the operations of all of the components of the drilling machine 12. The machine control system 14 preferably comprises a plurality of sensors 48 and a main control circuit 50. Each of the sensors 48 is positioned and operates to detect various machine events and senses data relative to selected operational parameters or the environment of the drilling machine 12. Each sensor 48 also transmits data signals representative of the information and data that were sensed. As used herein, sensors will be understood to mean any devices suitable for gathering selected information, such as mechanical devices, photoelectric devices, resistive devices, encoders, transducers, timers, or operator input devices, and adapted to transmit that information.

The main control circuit 50 receives signals from the plurality of sensors 48, and controls selected components or operations of the drilling machine 12 in response to those signals. Preferably, separate control circuitry and a cooperative sensor group comprising a subset of the plurality of sensors control individual components or operations of the drilling machine 12. The main control circuit 50 is provided to coordinate the operation of the various control circuitry. As used herein, circuitry can be any means of communicating information and data, such as electrical or hydraulic circuits, wire communications, or laser, infrared or radio communications.

Traditionally, the operations associated with a drilling machine and the drilling or backreaming operation have been performed largely, if not exclusively, by the operator and experienced crews, with the assistance of mechanical systems. One advantage of the present invention is that it provides an apparatus to automatically perform the basic functions of the drilling machine. 12.

The Automatic Drilling Process

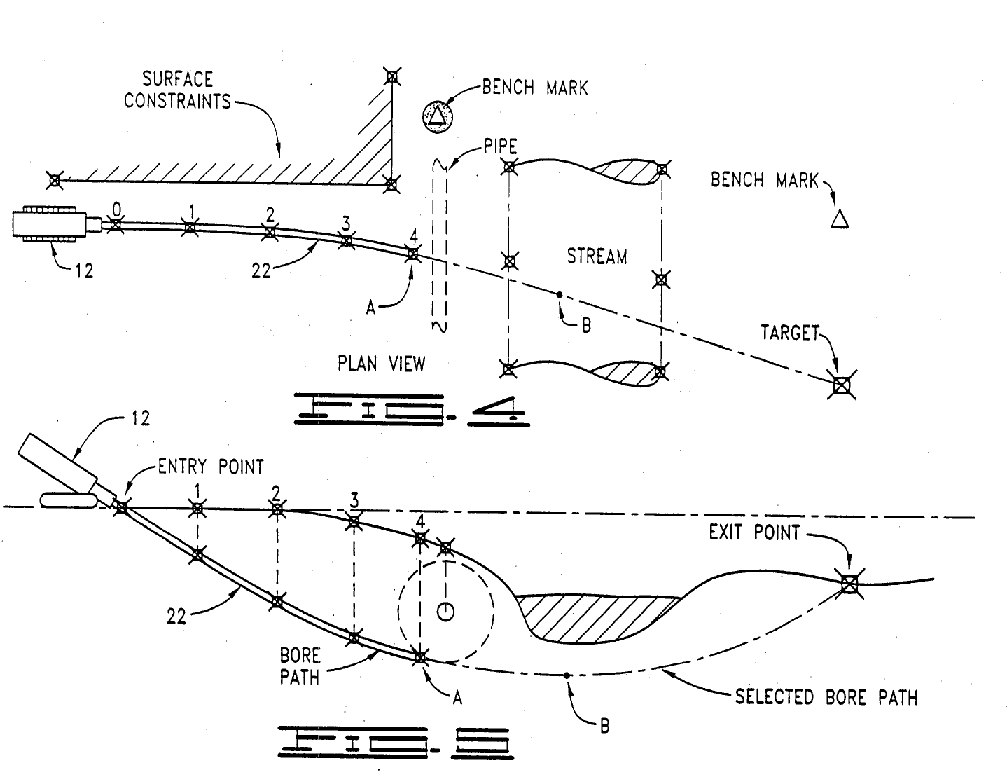

The drilling operation of the present invention consists of using the drilling machine 12 to advance the drill string 22 through the earth along a selected bore path, without operator intervention. FIGS. 4 and 5 represent a plan view and a side view, respectively, of a selected bore path or bore plan. The selected plan is mapped in advance of the drilling operation and ideally will be calculated based on a variety of parameters such as job site topography, desired entry and exit points, and location and clearance zones of existing utility lines and easements. Consideration is also given to the types of media to be bored through, the bend radius requirements of both the drill string and the product to be installed, and known cover minimums for crossing below roads, waterways, and the like. The bore plan provides an optimal course for the borehole, avoiding existing utilities and geographic landmarks, and identifying recommended beginning and ending points and recommended entry and exit angles.

Preferably, the beginning point and the ending point of the selected bore path will be located above ground or on the earth's surface, with the ending point remote from the beginning point. The selected bore path is an underground path connecting the beginning point and the ending point. More preferably, a bore path is comprised of a plurality of bore path segments, each having a beginning point and ending point. The bore path segments, in the aggregate, comprise the bore path with its beginning point and ending point above ground. For use with the drilling system 10 of the present invention, the selected bore path can be any underground path connecting any beginning point and ending point.

While the bore plan shown in FIGS. 4 and 5 represents a plan for the entire operation, a plan for a selected bore path could represent any segment of the operation as well. For example, the selected bore path could be represented by the segment of the plan in FIG. 4, as denoted by the reference letters A-B. In that case, with the downhole tool 24 and the end of the drill string 22 at position A, the automated drilling system 10 would advance and guide the downhole tool and the drill string along the selected bore path (segment A-B) to position B.

With a bore plan identified, the automated functions of the drilling system 10 can be used to automatically bore the borehole. The machine control system 14 automatically controls the operation of the drilling machine 12 as the drill string 22 is guided along the selected bore path A-B. With reference again to FIG. 3, the machine control system 14 preferably comprises a plurality of sensors 48 and a main control circuit 50. The machine control system 14 may be comprised of a plurality of subsystems, where each of the subsystems separately may comprise a plurality of sensors and control circuitry for controlling individual components or operations of the drilling machine 12. The main control circuit 50 is provided to coordinate the operation of the various control circuitry.

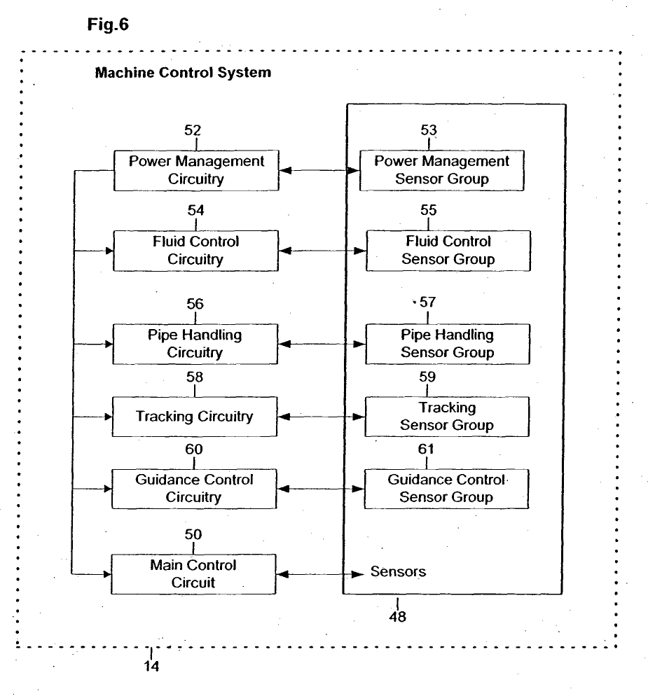

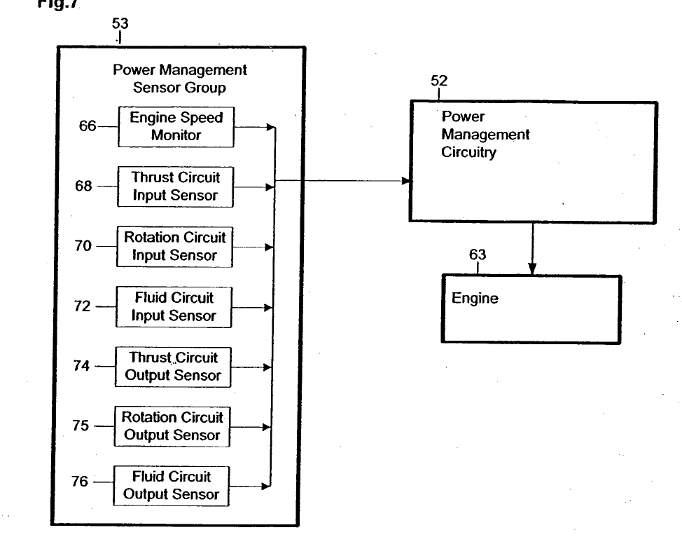

In the preferred embodiment shown in FIG. 6, the machine control system 14 comprises power management circuitry 52 and a power management sensor group 53 for operating the power system, fluid control circuitry 54 and a fluid control sensor group 55 for operating the fluid dispensing system 19, pipe handling control circuitry 56 and a pipe handling sensor group 57 for operating the pipe handling system 20, tracking circuitry 58 and a tracking sensor group 59 for obtaining and communicating information about the location and orientation of the downhole tool 24, and guidance control circuitry 60 and a guidance control sensor group 61 for operating the drive system 18 and controlling the direction, position and orientation of the downhole tool. Each of the control circuitry and sensor group pairs monitors and operates a component of the drilling machine 12. By coordinating and monitoring the operation of the various control circuitry and sensor groups, the machine control system 14 manages the automated drilling or backreaming operation.

Guiding the downhole tool 24 along the selected bore path A-B (see FIG. 4), as described herein, is accomplished by coordinated operation of the power management circuitry 52, the fluid control circuitry 54, the pipe handling control circuitry 56, the tracking circuitry 58, and the guidance control circuitry 60. The operation may be complemented with error-feedback loops to correct any errors in the operation of the drilling machine 12 or deviation from the selected bore path A-B. For example, the tracking circuitry 58 and the tracking sensor group 59 sense and provide data indicative of the position and orientation of the downhole tool 24. The main control circuit 50, in response to the data received from the tracking circuitry 58, uses the guidance control circuitry 60 to guide the downhole tool 24, maneuvering it along the selected bore path.

The data indicative of the position and orientation of the downhole tool 24 can be used with other data from the operation of the drilling machine 12 to determine the actual path followed by the drill string 22 and the downhole tool. For example, using the pitch of the downhole tool 24 and the distance bored for a segment of the drilling operation and the surface topography, the expected change in depth can be determined. Similar identification of the actual location of the downhole tool 24 can be made using data from the plurality of sensors 48. As used herein, the use of “actual” to describe the path being bored or the location of the downhole tool 24 will be understood to mean the expected or estimated path or location as determined from the available information.

As the drilling operation is commenced to advance the drill string 22 along the selected bore path A-B. the power management circuitry 52, the fluid control circuitry 54, the pipe handling control circuitry 56, the tracking circuitry 58, and the guidance control circuitry 60 may all be operational and used concurrently.

Power Management System

The present invention provides for optimization of power usage by the drilling machine 12 and its components through the use of a power management function. The optimization is achieved through automatic control of the power system by the power management circuitry 52. In the preferred embodiment, the power management circuitry 52 will maximize the power usage of the drive system 18 and the fluid dispensing system 19 during drilling or backreaming. However, additional hydraulic pumps or other power sources can be added and automatically controlled as needed.

As depicted in FIG. 7, the power management circuitry 52 receives data from the power management sensor group 53 and controls the output of the engine 63, depending on the power requirements of the drive system 18 and the fluid dispensing system 19. In a first preferred embodiment, the engine 63 is operated at idle or full speed depending on the power requirements. In a second embodiment, the engine 63 output can be increased and decreased incrementally depending on the consumption requirements of the components of the drilling machine 12. As an example, when power is required, the power management circuitry 52 can bring the engine 63 to an optimum speed for conservation of fuel consumption and power usage. Then, if the components of the drilling machine 12 require additional power after being operated at their maximum levels, the power management circuitry 52 will increase the engine 63 speed gradually until power requirements are satisfied. When additional power is not required, the engine 63 speed can gradually be reduced to the optimum level, at the maximum operating efficiency of the engine.

In the preferred embodiment, the power management sensor group 53 comprises an engine speed monitor 66, a thrust circuit input sensor 68, a rotation circuit input sensor 70, and a fluid circuit input sensor 72. The engine need monitor 66 tracks the output of the engine 63. Using a speed pickup sensor on the engine 63, for example, magnetic pulses can be counted and correlated to the engine output. The engine speed monitor 66 transmits an ENGINE SPEED signal to the power management circuitry 52. Alternatively, the performance of the engine 63 can be monitored by tracking fuel consumption, exhaust temperature, or torque.

The thrust circuit input sensor 68, the rotation circuit input sensor 70, and the fluid circuit input sensor 72 monitor the input voltage to the various circuits. When the respective circuits are receiving an input voltage and thus requiring power, the sensors transmit a THRUST CIRCUIT FULL signal, a ROTATION CIRCUIT FULL signal, or a FLUID CIRCUIT FULL signal as appropriate to the power management circuitry 52. Alternative methods of monitoring the power needs of the hydraulic circuits are available, such as by monitoring the displacement of the pumps in the hydraulic circuits. In response to the ENGINE SPEED signal and the signals from the circuit sensors 68, 70, and 72, the power management circuitry 52 automatically operates the engine 63 as necessary.

The thrust circuit output sensor 74, the rotation circuit output sensor 75, and the fluid circuit output sensor 76 sense the output of the various circuits by monitoring speeds of the pump in the respective circuits. The pump speeds in the respective circuits can be correlated to an output capacity for each circuit. The sensors 74, 75, and 76 may be speed pickup sensors on the respective motors to track the motor speeds. The thrust circuit output sensor: 74, the rotation circuit output sensor 75, and the fluid circuit output sensor 76 transmit a THRUST CIRCUIT OUTPUT signal, a ROTATION CIRCUIT OUTPUT signal, or a FLUID CIRCUIT OUTPUT signal as appropriate to the power management circuitry 52. Alternative methods of monitoring the output of the circuits are available, such as by monitoring the voltage output from each of the circuits. Additionally, the present invention contemplates only a single sensor being required where, for example, a single pump is used to provide power to the motors of each circuit. In response to the ENGINE SPEED signal and the signals from the circuit input sensors 68, 70, and 72, and the circuit output sensors 74, 75, and 76, the power management circuitry 52 automatically operates the engine 63 as necessary.

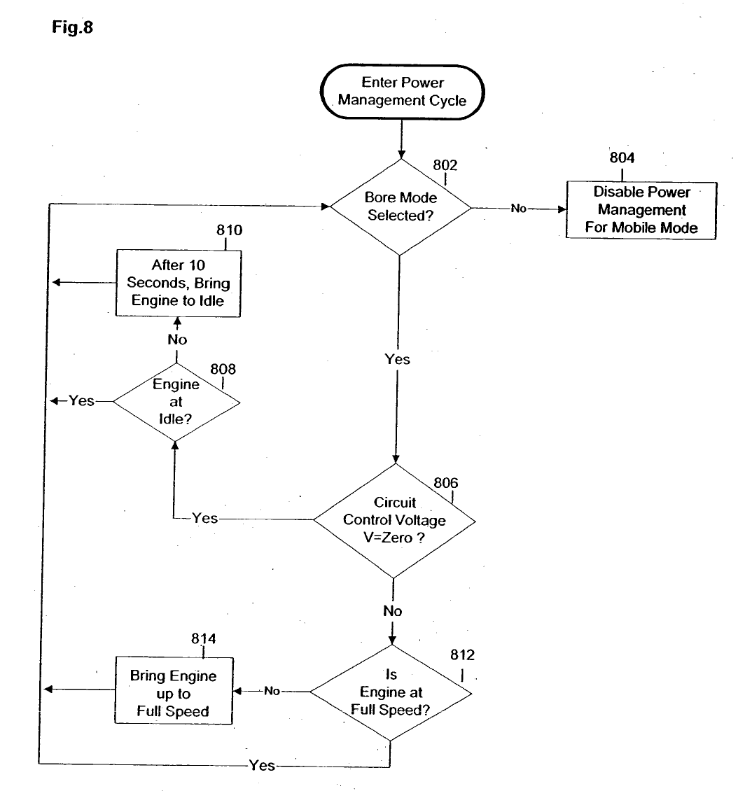

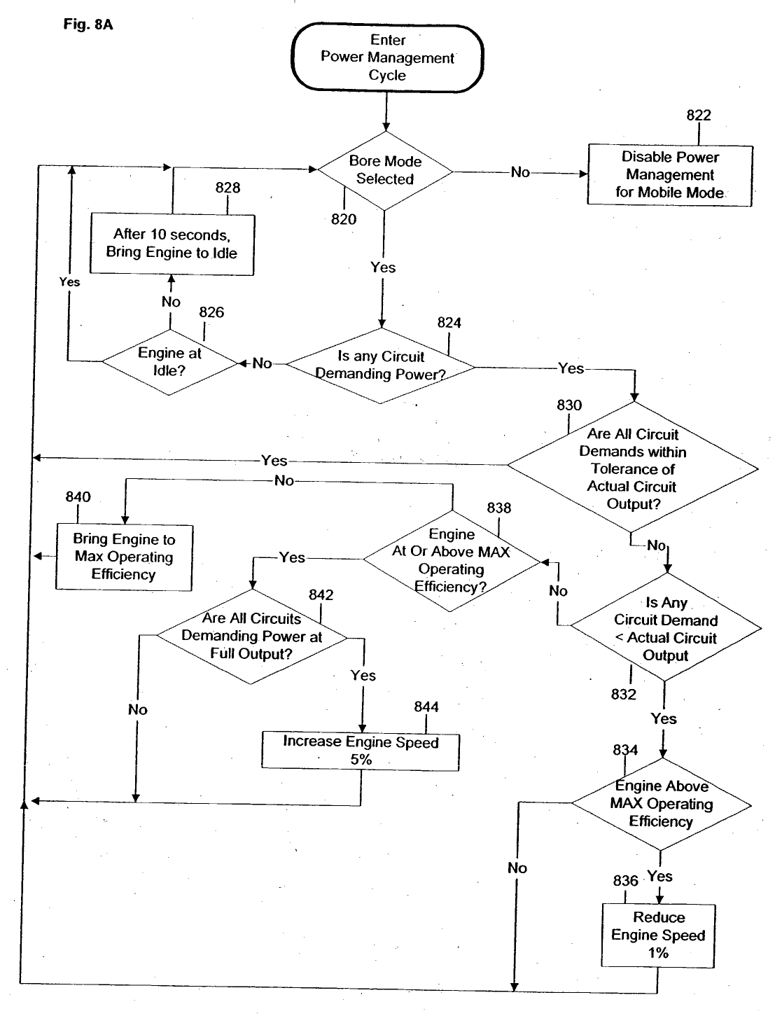

FIG. 8 illustrates the logic followed by the power management circuitry 52 for the first embodiment described above, as it automatically controls the engine 63 that supplies power for the drive system 18 and the fluid dispensing system 19. An initial check is made at 802 to determine if the drilling machine 12 is in the drilling mode. The power management routine is disabled at 804, as the routine is used only when power is needed for drilling or backreaming. The power management circuitry 52 serves no purpose when the engine 63 is used for setup or transport of the drilling machine 12. If the drilling machine 12 is in the drilling mode, the voltage inputs to the hydraulic circuits are checked at 806 to determine if the hydraulic circuits require power. If no hydraulic circuit is on and requiring power, a check is made at 808 to determine if the engine 63 is set to idle. If the engine is not at idle, a delay routine is run at 810 to set the engine 63 to idle if there is no demand for power from the hydraulic circuits for 10 seconds. If at 808 the engine 63 is already at idle, the power management routine continues by monitoring the hydraulic circuits for a need for power. If a hydraulic circuit does require power at 806, then a check is made at 812 to see if the engine is at full speed. If the engine is not at full speed, at 814 the engine 63 speed is increased to satisfy the demand for power.

FIG. 8A illustrates alternative logic followed by the power management circuitry 52 in the second embodiment described above as it automatically controls the engine 63 that supplies power for the drive system 18 and the fluid dispensing system 19. An initial check is made at 820 to determine if the drilling machine 12 is in the drilling mode. The power management routine is disabled at 822 if the routine is not in the drilling or backreaming mode, as the routine is used only when power is needed for drilling or backreaming. If the drilling machine 12 is in the drilling mode, the voltage inputs to the hydraulic circuits are checked at 824 to determine if the hydraulic circuits require power. If no hydraulic circuit is on and requiring power, a check is made at 826 to determine if the engine 63 is set to idle. If the engine 63 is not at idle, a delay routine is run at 828 to set the engine 63 to idle if there is no demand for power from the hydraulic circuits for 10 seconds. If at 826 the engine 63 is already at idle, the power management routine continues by monitoring the hydraulic circuits for a need for power.

If a hydraulic circuit does require power at 824, then a check is made at 830 to see if the inputs for the circuits correspond, within a designated tolerance level, of their actual output levels. If the circuit outputs are all at their expected levels, the power management routine begins again at 820.

If the output of any circuit is not as expected at 830, then at 832 the outputs of the circuits are checked to see if any of the actual outputs are greater than the corresponding inputs. If any circuit output does exceed the expected output by the tolerance, then at 834 the engine 63 is monitored to determine if it is operating above its maximum operating efficiency. If the engine 63 is above the optimum level, the engine speed is reduced slowly, by 1%, at 836. After the engine 63 speed is reduced, or if the engine is already at the optimum level, the power management routine cycles again at 820.

If no circuit output is above its expected level at 832, the engine 63 is monitored at 838 to determine if it is operating at or above its maximum operating efficiency. If the engine 63 is operating below its optimum level, the engine output is increased to its maximum efficiency level at 840. If the engine 63 is at or above the optimum level at 838, the check at 842 determines if all circuits are at their maximum output levels. If the circuits are at their maximum output levels, the engine 63 speed is increased 5% to try to satisfy the increased demand for power. After the engine 63 speed is increased, or if any circuits are not yet at their maximum output, the power management routine cycles again at 820.

Fluid Control System

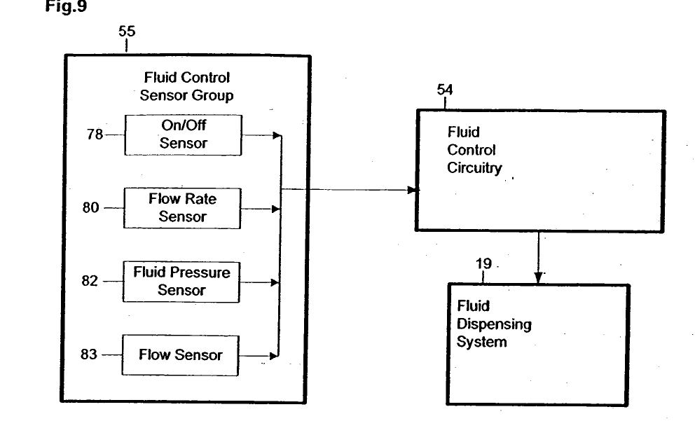

The present invention also provides for the automatic control of the fluid dispensing system 19 using a fluid control function. The fluid control function is implemented using the fluid control circuitry 54, as shown in FIG. 9. The fluid control circuitry 54 receives data from the fluid control sensor group 55 and controls the output of the fluid dispensing system 19 in response to that data. The fluid control sensor group 55 may sense data relative to fluid flow rate, fluid pressure, fluid levels, and fluid viscosity. In the preferred embodiment, the fluid control sensor group 55 comprises an on/off sensor 78, a flow rate sensor 80, and a fluid pressure sensor 82. The fluid control circuitry 54 and the fluid control sensor group 55 allow the system to detect and respond to proper fluid flow or no flow due to blockage or lack of supply.

The on/off sensor 78 transmits a FLUID ON signal indicating when the fluid dispensing system 19 is to be on or off. In response to the FLUID ON signal, the fluid control circuitry 54 automatically operates the fluid dispensing system 19. Preferably, fluid is dispensed whenever the drill string is being axially moved or rotated. In the preferred embodiment, the on/off sensor 78 will monitor the thrust circuit and the rotation circuit to determine when they are providing axial movement or rotation to the drill string 22. The thrust circuit input sensor 68 and the rotation circuit input sensor 70, for example, could be used to determine when the thrust and rotation circuits are on. Alternatively, in an embodiment in which wrenches are used to stabilize the drill string for the pipe handling system 20, the on/off sensor may be a switch indicating when the wrenches are engaged so that the drill string 22 is not being axially moved or rotated.

The flow rate sensor 80 provides an indication of the rate of flow from the fluid dispensing system 19. The flow rate sensor 80 measures the flow rate of the fluid circuit in the fluid dispensing system 19 by monitoring the rotation speed of the fluid circuit drive motor or pump. The flow rate sensor 80 transmits a FLOW RATE signal to the fluid control circuitry 54. The fluid pressure sensor 82 is a pressure transducer that monitors the pressure output of the fluid dispensing pump. The fluid pressure sensor 82 transmits a FLUID PRESSURE signal to the fluid control circuitry 54. The flow sensor 83 detects when there is fluid flow present. The flow sensor 83 may be a spring loaded ball or plunger that is unseated when flow is established. The movement of the ball or plunger is detected by a proximity switch, enabling a FLOW ON signal to the fluid control circuitry 54. In response to the FLOW RATE signal, the FLUID PRESSURE signal, and the FLOW ON signal, the fluid control circuitry 54 automatically operates and controls the output of the fluid dispensing system 19. As an alternative to either the flow rate sensor 80 or the flow sensor 83, other devices such as an in-line fluid flow meter may be used to sense the flow rate and fluid flow.

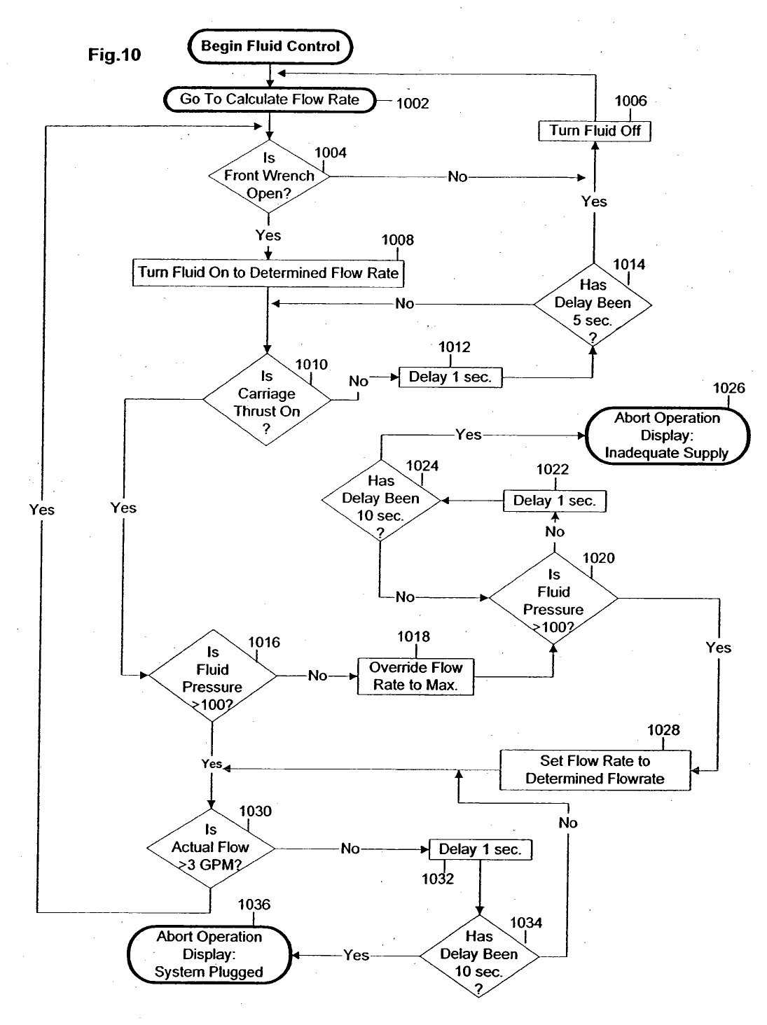

The logic for the automatic control of the fluid dispensing system 19 is illustrated in FIG. 10. In the first step in controlling the fluid dispensing system 19, the desired flow rate is calculated at 1002 for the fluid dispensing system 19. The flow rate may be set at the maximum for the fluid dispensing system 19, regardless of whether the system is used during the drilling or backreaming operation. Preferably, the flow rate is adjusted for the drilling and backreaming operations and depending on a variety of parameters. For example, for a drilling operation the desired flow rate may be calculated using parameters such as the diameter of the drilling bit, diameter of the drill pipe, the type of soil, the fluid mixture being used, and the carriage advance rate. In a backreaming operation, the desired flow rate may be calculated using parameters such as the type of reamer, the diameter of the reamer, the type of soil, the size of the product being installed, and the mud mixture being used.

After the flow rate is calculated, the FLUID CONTROL routine checks to see if the drill string 22 is being rotated and thrust or pulled at 1004. In the preferred embodiment, where wrenches are used to secure the drill string 22 during operation, the check at 1004 can be made by determining if the wrenches have secured the drill string and prevented it from moving. Alternatively, sensors such as the thrust circuit input sensor 68 and the rotation circuit input sensor 70, previously described, can be used to monitor the rotation and axial movement of the drill string 22. If the drill string 22 is not being rotated and axially moved, the fluid is turned off at 1006. If the drill string 22 is being rotated or axially moved, the fluid is turned on and set to the desired flow rate at 1008. A check is then made at 1010 to determine if the carriage 36 is being thrust forward or pulled back. If there is no thrust or pull back, the delay cycle of 1012 and 1014 is initiated. If there has been no thrust or pull from the carriage 36 for 5 seconds, the fluid is turned off at 1006 and the FLUID CONTROL routine begins again.

When the carriage is being axially moved, the fluid pressure is checked at 1016. If the fluid pressure is less than a required minimum, such as 100 psi, the flow rate is set to the maximum rate at 1018. The fluid is dispensed at the maximum flow rate until the fluid pressure exceeds the required minimum, with that determination made at 1020. The delay routine of 1022 and 1024 checks to see if the fluid pressure remains below the minimum level for ten seconds. If the pressure does remain below the minimum for ten seconds, the operation is aborted at 1026 for lack of fluid. When the fluid pressure exceeds the minimum, the fluid is again dispensed at the desired flow rate at 1028. Discrete values specified for fluid pressure checks, flow rate checks, time intervals, and other discrete values used herein are presented as examples only. Specific values may vary with different drilling machines and drilling conditions. Preferably, values can be set by the operator prior to the operation and will accommodate for equipment capabilities and characteristics.

At 1030, the flow sensor 83 checks to see if there is actual fluid flow. If there is no fluid flow for ten seconds, as determined at 1032 and 1034, then the operation is aborted at 1036. Otherwise, the flow of fluid is normal and the FLUID CONTROL routine repeats.

Pipe Handling Control System

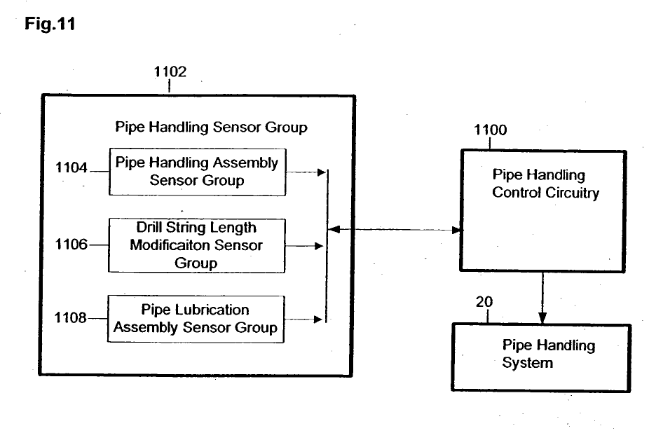

The automatic control of the pipe handling system 20 is accomplished with a pipe handling function. The pipe handling function of the preferred embodiment is detailed in U.S. application Ser. No. 09/146,123, previously incorporated by reference. The pipe handling system 20 comprises a pipe handling assembly adapted to store and transport pipe sections to and from a connection area, a drill string length modification assembly adapted to make up and break out the drill string, and a pipe lubrication assembly adapted to apply lubricant to selected pipe joints. As shown in FIG. 11, pipe handling control circuitry 1100 and a pipe handling sensor group 1102 provide for automatic control of the pipe handling system 20. The pipe handling sensor group 1102 comprises a pipe handling assembly sensor group 1104, a drill string length modification sensor group 1106, and a pipe lubrication assembly sensor group 1108. The pipe handling control circuitry comprises handling assembly circuitry adapted to receive data from the pipe handling assembly sensor group and to automatically operate the pipe handling assembly, drill string length modification circuitry adapted to receive data from the drill string length modification assembly sensor group and to automatically operate the drill string length modification assembly, and pipe lubrication control circuitry adapted to receive data from the pipe lubrication assembly sensor group and to automatically operate the pipe lubrication assembly.

Tracking System

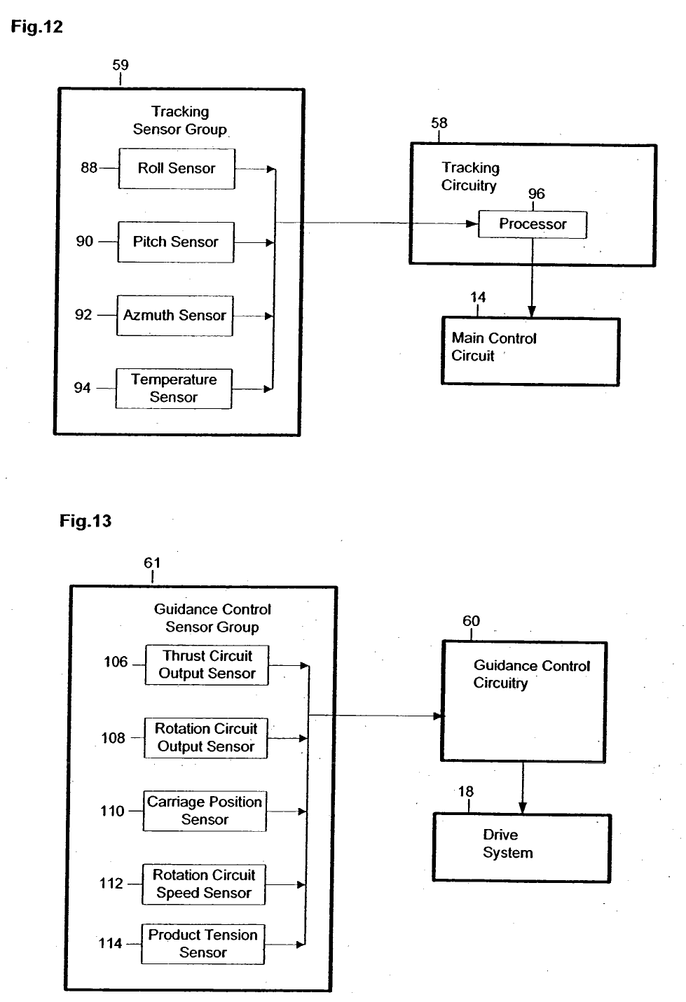

A tracking function is provided by the tracking circuitry 58. The tracking circuitry 58 monitors the location and orientation of the downhole tool 24 and communicates that information to the machine control system 14 for use by other systems, such as the guidance control circuitry 60, yet to be described. In the preferred embodiment, shown in FIG. 12, the tracking circuitry 58 receives data from the tracking sensor group 59, makes determinations about the location and orientation of the downhole tool 24, and communicates that information to the main control circuit 14. The tracking sensor group 59 comprises a roll sensor 88, a pitch sensor 90, an azimuth sensor 92, and a temperature sensor 94. The tracking control circuitry 58 may comprise a processor 96 that receives data from the tracking sensor group 59 and transmits that data to the machine control system 14. It is contemplated that additional information may be obtained from the downhole tool 24 for use by other systems. For example, shock and vibration values, the level of charge in an on-board battery (not shown), downhole tool 24 wear indicators, flow sensing, and product tension values all may be obtained from the downhole tool.

The roll sensor 88, the pitch sensor 90, the azimuth sensor 92, and the temperature sensor 94 are located proximate to the downhole tool 24. The roll sensor 88, the pitch sensor 90, and the azimuth sensor 92 monitor the location and orientation of the downhole tool 24. The roll sensor 88 detects the relative rotational position of the downhole tool 24 and transmits a ROLL POSITION signal indicative of the relative rotational position. Roll sensors 88 capable of being used with the present invention are commercially available as small multiple-pole mercury wetted switches. Alternatively, accelerometers can also be used to measure the rotational position of the downhole tool 24.

The pitch sensor 90 detects the relative inclination of the downhole tool 24 as it deviates from a horizontal plane. The pitch sensor 90 also transmits a PITCH signal that represents the angular pitch of the downhole tool 24. A pitch sensor 90 suitable for use with the present invention is described in U.S. Pat. No. 5,880,680, entitled Apparatus and Method for Determining Boring Direction When Boring Underground, issued on Mar. 9, 1999, the contents of which are incorporated herein by reference. The azimuth sensor 92 detects the orientation of the downhole tool 24, usually relative to the earth's magnetic field, and transmits an ORIENTATION signal. A suitable azimuth sensor 92 is described in U.S. Pat. No. 5,850,624, entitled Electronic Compass, issued on Dec. 15, 1998, the contents of which are incorporated herein by reference.

The temperature sensor 94 monitors the temperature of the downhole tool 24 and transmits a TEMPERATURE signal. The temperature data can be used to compensate for errors in the other sensors that might be caused by elevated temperatures. An example of such temperature compensation can be found in U.S. Pat. No. 5,880,680, previously incorporated by reference. The temperature data is also used to alert the main control circuit 50 when elevated temperatures could result in downhole electronics being damaged by excessive heat. In such a situation the fluid control system 19 can be operated to increase the fluid flow rate, in an effort to reduce the temperature of the downhole tool 24.

The tracking control circuitry 58 receives the signals from the tracking sensor group 59 and processes those signals before communicating the data for use by the main control circuit 50. The processor 96 in the tracking control circuitry 58 receives the signals from the roll sensor 88, the pitch sensor 90, the azimuth sensor 92, and temperature sensor 94. The processor 96 may also transform the signals into data for use by the machine control system 14. For example, the TEMPERATURE signal may be used to adjust the ROLL POSITION signal, the PITCH signal, and the ORIENTATION signal to compensate for the effect of temperature on the sensors 88, 90, and 92.

The processor 96 of the tracking circuitry 58 also transmits the data received from the sensors 88, 90, 92, and 94, at their position proximate the downhole tool 24, to the machine control system 14 on the drilling machine 12 In the preferred embodiment, the signals from the processor 96 are transmitted through the drill string 22, with the drill string acting as an electrical conductor. A pickup coil 98 (shown in FIG. 2) surrounding the drill string 22 and located at the drilling machine 12 receives the electrical signals by sensing the electrical signals transmitted along the drill string. The signals can then be used by the machine control system 14 to monitor the location and orientation of the downhole tool 24. Various alternatives are available for communicating the signals from the processor 96 to the machine control system 14, such as extending a wire line through the length of the drill string 22 that can carry the data signals from the processor to the machine control system, communicating the signals sonically through drilling fluid or the earth, or using radio frequency transmissions.

In addition to the tracking system described herein, the inventions provided in U.S. application Ser. No. 08/999,166, filed on Dec. 30, 1997, and entitled System and Method for Detecting an Underground Object Using Magnetic Field Sensing, and in U.S. Pat. No 4,881,083, issued to FlowMole Corporation on Oct. 2, 1989, and entitled Homing Technique for an In-Ground Boring Device, present techniques that are applicable to the tracking system. The contents of the application and the issued patent are incorporated herein by reference.

Other known techniques for tracking downhole tools 24 may also be used with the present invention. For example, techniques such as the global positioning system (GPS) or ground penetrating radar could be used to determine the location of the downhole tool 24. Walkover trackers, prevalent in the horizontal directional drilling industry, may also be used during certain portions of a drilling operation when increased accuracy for determining depth and location of a downhole tool 24 is required. As an example, a walkover tracker with GPS capabilities could provide extremely accurate location information about the downhole tool 24. The GPS unit on the tracker would provide the precise latitude and longitude of the downhole tool 24 and magnetic field sensors in the tracker would provide precise depth information for the downhole tool. Used with the drilling system 10 of the present invention, one or more of the plurality of sensors 48 could be adapted to receive location information transmitted by the tracker of the example. The information then could be passed to the main control circuit 50 for use in guiding the downhole tool 24 along the selected bore path.

Guidance Control System

During the drilling operation, the guidance control circuitry 60 provides a guidance control function and advances the drill string 22 along the selected bore path A-B, making corrections as necessary, by operating the drive system 18 in response to information received from the main control circuit 50 and the tracking circuitry 58. The guidance control circuitry 60 advances the downhole tool 24 in a straight line by simultaneously providing thrust and rotation to the drill string 22. The drive system 18 may provide maximum thrust and rotation of the drill string 22 as the drilling tool is advanced in a straight line. Preferably, however, thrust will be limited to 60% of maximum when the carriage 36 is in the back portion of the spindle connection area, limited to 80% of maximum in the middle portion of the spindle connection area, and 100% thrust will be allowed in the front portion of the spindle connection area. Limiting thrust in this manner limits stress placed on the exposed portion of the drill string 22 and thereby reduces the potential for buckling the exposed portion of the drill string.

As is commonly known in the industry, it may be necessary to further limit the applied thrust so as not to exceed the holding ability of the anchoring system. The present invention is described as if the anchoring system rigidly holds drilling machine 12 to the earth. It is contemplated that adaptations can be made to sense the onset of reactionary movement of the drilling machine 12. Movement of the drilling machine 12 can be sensed, for example, by an optical sensor or other motion sensor deployed to detect movement relative to the earth, or by a stringline potentiometer connected to a stake driven in the earth. Movement of the drilling machine 12 can be compensated for where appropriate by the machine control system 14 and operations aborted in the event a threshold of movement with respect to the earth is exceeded. The threshold of allowable movement is preferably set prior to beginning operations and varies with the entry angle, the diameter of the drill string 22, and the design configuration of the threaded connections. If the threshold is exceeded and operations are aborted, the operating crew would reposition the drilling machine 10 and deploy additional anchoring before resuming operations.

To change the direction of the drill string 22, any known steering technique may be used. As previously described, the preferred embodiment employs a slant-faced drill bit that is oriented and thrust to change direction. As the slant-faced drill bit is thrust without rotation, the drill bit is pushed in the direction of the slant face, thereby changing the direction of the drill string 22. Other embodiments for a drill bit to be used as the downhole tool 24 are contemplated for use with the present invention. U.S. Pat. No. 4,858,704, entitled Guided Earth Boring Tool and issued on Aug. 22, 1989, U.S. Pat. No. 5,392,868, entitled Direction Multi-Blade Boring Head and issued on Feb. 28, 1995, and U.S. Pat. No. 5,799,740, entitled Directional Boring Head with Blade Assembly and issued on Sep. 1, 1998, each describe various drill bits that could be used with the present invention. Additionally, other techniques for changing the direction of the drill string 22 are known in the industry and are contemplated for use with the present invention. For example, dual member pipes with a steering mechanism such as is described in U.S. Pat. No. 5,490,569, entitled Directional Boring Head with Deflection Shoe and Method of Boring, and issued on Feb. 13, 1996; angled fluid jets used for cutting in a new direction such as described in U.S. Pat. No. 4,674,579, issued to FlowMole Corporation on Jun. 23, 1987, and entitled Method and Apparatus for Installment of Underground Utilities; and other contemplated steering techniques such as oscillating the drill bit, using downhole motors for turning the drill bit, or injecting resistant material for use as a biasing force in the borehole could all be used in conjunction with the present invention. The contents of the aforementioned patents are incorporated herein by reference.

As shown in FIG. 13, the guidance control circuitry 60 receives data from the guidance control sensor group 61. The guidance control circuitry 60 monitors the status of the drive system 18 and operates the drive system to change the location of the downhole tool 24. The guidance control sensor group 61 comprises a thrust circuit output sensor 106, a rotation circuit output sensor 108, a carriage position sensor 110, a rotation circuit speed sensor 112, and a product tension sensor 114.

The thrust circuit output sensor 106, the rotation circuit output sensor 108, the carriage position sensor 110, and the rotation circuit speed sensor 112 are located on the drilling machine 12 and provide the guidance control circuitry 60 with data relevant to the operation of the drive system 18. The thrust circuit output sensor 106 monitors the amount of thrust being applied to the drill string 22 by the thrust circuit. The thrust circuit output sensor 106 transmits a THRUST PRESSURE signal indicative of the thrust on the drill string 22. In the preferred embodiment, the thrust circuit output sensor 106 is a pressure transducer on the hydraulic pump 30 of the thrust circuit.

The rotation circuit output sensor 108 monitors the amount of rotation applied to the drill string 22 by the rotation circuit. The rotation circuit output sensor 108 transmits a ROTATION PRESSURE signal indicative of the rotation of the drill string 22. In the preferred embodiment, the rotation circuit output sensor 108 is a pressure transducer on the hydraulic pump 32 of the rotation circuit.

The carriage position sensor 110 tracks the position of the carriage 36 by monitoring the thrust circuit. The operation of the thrust circuit can be correlated to the movement of the carriage 36 throughout its path of travel. Using a speed pickup sensor, for example, magnetic pulses from a motor in the thrust circuit can be counted and the direction and distance the carriage 36 has traveled can be calculated. Other methods for tracking the carriage 36 are also possible, such as photoelectric devices, mechanical devices, resistive devices, encoders, and linear displacement transducers that can detect carriage movement and position. The carriage position sensor 110 also transmits a CARRIAGE POSITION signal to the guidance control circuit 60 indicating the relative position of the carriage 36.

The rotation circuit speed sensor 112 monitors the rotational speed of the drill string 22 by detecting the output of the rotation circuit. The rotation circuit speed sensor 112 transmits a SPINDLE SPEED signal indicative of the rotational speed of the drill string 22. In the preferred embodiment, the rotation circuit speed sensor 112 is a speed pickup sensor on the drive train for the spindle 34.

The product tension sensor 114 is positioned to detect the tension on a product or utility line being installed in a borehole during a backreaming operation. The product tension sensor 114 is preferably located proximate the downhole tool 24 during the backreaming operation and transmits a PRODUCT TENSION signal indicative of the tension being exerted by the downhole tool 24 on the product being installed. A product tension sensor suitable for use with the present invention is described in U.S. Pat. No. 5,833,015, issued to Tracto-Technik Paul Schmidt Spezialmaschinen, on Nov. 10, 1998, and entitled Method and Apparatus for Sinking Pipes or.Cables Into a Pilot Borehole, and U.S. Pat. No. 5,961,252, issued to Digital Control, Inc., on Oct. 5, 1999, and entitled Underground Utility Installation Tension Monitoring Arrangement and Method, the contents of which are incorporated herein by reference.

In response to the THRUST PRESSURE signal, the ROTATION PRESSURE signal, the CARRIAGE POSITION signal, the SPINDLE SPEED signal, and PRODUCT TENSION signal the guidance control circuitry 60 operates the drive system 18.

The control logic for the guidance control circuitry 60 comprises a plurality of routines designed to operate the drive system 18 and steer the downhole tool 24 along the selected bore path. As indicated previously, the selected bore path can be represented as a series of segments, such as segment A-B shown in FIG. 5. Furthermore, each segment A-B can be said to comprise a series of bore segments connected at direction change points. The guidance control circuitry 60, then, moves the downhole tool 24 and the drill string 22 in a straight line until a direction change point is encountered. At the direction change point, the downhole tool 24 is redirected so that the drill string 22 may then follow the next bore segment. The process of automatically drilling along the desired bore path thus can be a repetitive process.

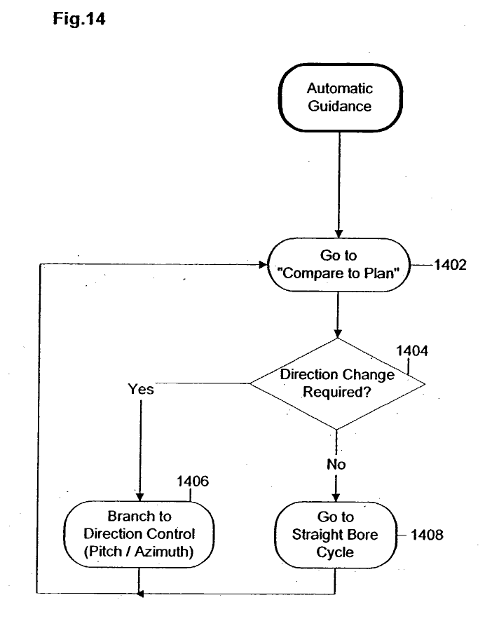

The main routine for the guidance control circuitry 60, shown in FIG. 14, is the AUTOMATIC GUIDANCE routine. At 1402, the COMPARE TO PLAN routine, yet to be described, is called to determine the distance for the straight bore or the change in direction that is needed. If, at 1404, it is determined that a change in direction is required, the DIRECTION CONTROL routine is called at 1406. If no direction change is required, the STRAIGHT BORE CYCLE routine is called at 1408. When the DIRECTION CONTROL routine or STRAIGHT BORE CYCLE routine returns, the process continues at 1402 with a call to the COMPARE TO PLAN routine.

Compare to Plan

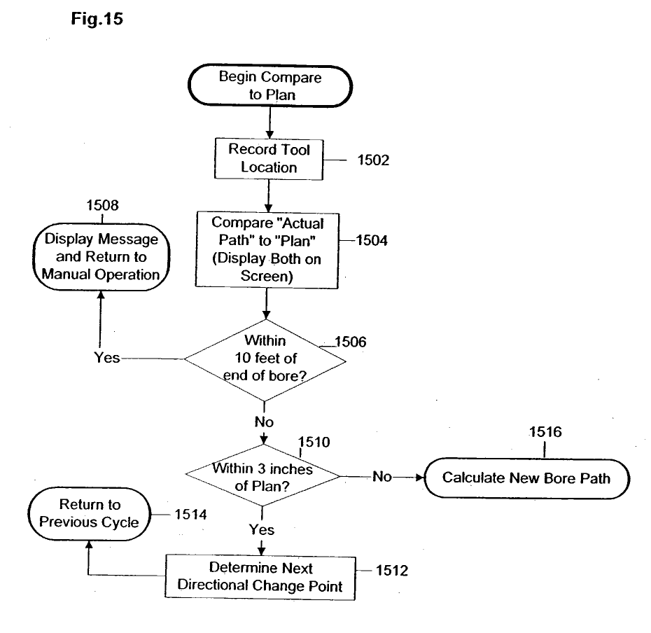

FIG. 15 illustrates the COMPARE TO PLAN routine for determining the distance for a straight bore segment or the change in direction that is required. The routine records at 1502 the actual location of the downhole tool 24 using data from the tracking sensor group 59 and information received from the tracking circuitry 58. At 1504, the actual location of the downhole tool 24 is compared with the selected bore path. Preferably, the actual path and the selected bore path are displayed on a screen at the control panel 28 (referring to FIG. 1). If the downhole tool is within a predetermined distance, such as ten feet, of the bore path's desired exit point, as determined at 1506, the automatic operation is stopped at 1508 and control returned to manual operation of the drilling system 10. If more drilling is necessary, a check is made at 1510 to see if the downhole tool 24 is within a predetermined tolerance of the selected bore path. When the downhole tool 24 and the drill string 22 are on the selected bore path, the distance to the next directional change point or the specified directional change needed is determined at 1512. This information is returned to the calling routine as the COMPARE TO PLAN routine is completed at 1514.

If the downhole tool 24 is not on the selected bore path at 1510, the drilling operation is temporarily aborted at 1516 for the purposes of calculating a new bore path. The calculation of a new bore path may involve determining an entire new bore path for the operation from the actual location of the downhole tool 24 to the desired exit point, or may involve determining a new drilling segment to return the downhole tool 24 to the selected bore path. When the new or correcting path is determined, the drilling operation can be continued.

Straight Bore Cycle

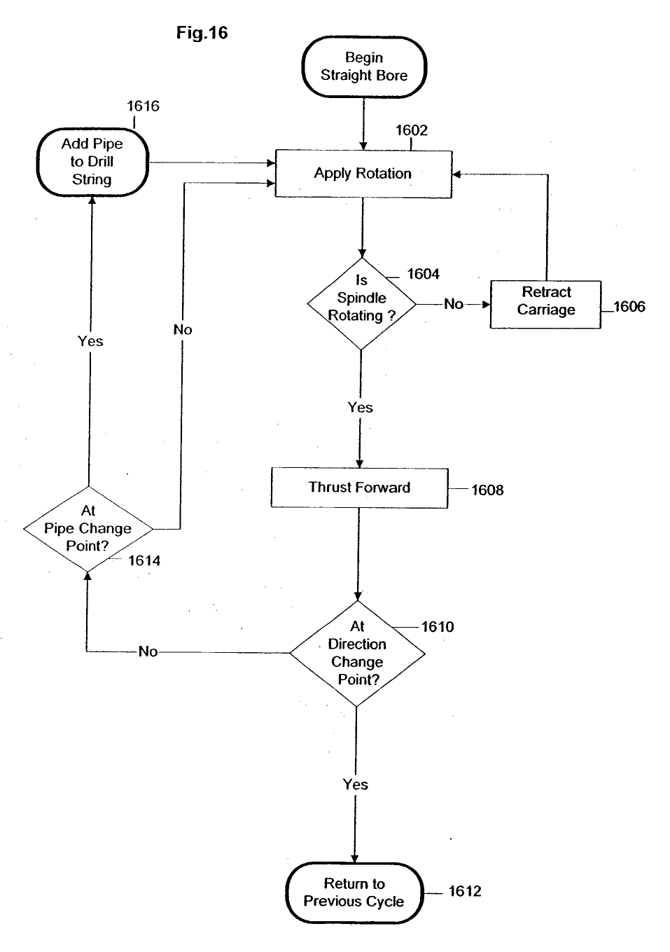

FIG. 16 illustrates the STRAIGHT BORE CYCLE routine for automatically guiding the drill bit in a straight line for a predetermined distance. The routine operates the drive system 18 to rotate the drill string 22 at 1602. At 1604, the spindle 34 is checked to see if it is rotating. If the spindle 34 is not rotating, the spindle and the carriage 36 are retracted two inches (or some predetermined amount) at 1606. The process of retracting the carriage 36 and spindle 34 is repeated until the spindle does rotate. Retracting the carriage 36 will in turn free the downhole tool 24 or the drill string 22 from whatever force is preventing rotation.

While the spindle 34 is rotating, the spindle is thrust forward at 1608. If the carriage has reached the end of the straight segment, as determined at 1610, the straight bore cycle is completed at 1612. If, however, the straight bore segment is not completed, a check is made at 1614 to determine if the carriage is at the forward end of its travel such that the drill string 22 must be lengthened using the pipe handling system 20. If the drill string 22 must be lengthened, then the drill string is lengthened at 1616. If the drill string 22 need not yet be lengthened and a direction change point has not been reached, the process of the STRAIGHT BORE CYCLE continues at 1602.

Direction Control Cycle

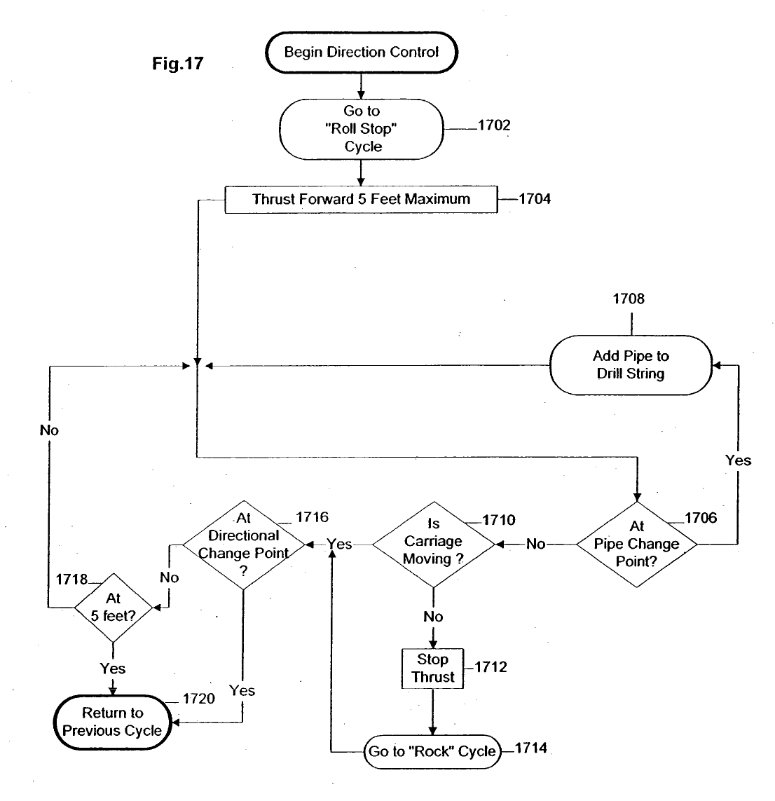

The DIRECTION CONTROL routine is illustrated in FIG. 17 and shows the logic for changing the pitch and/or orientation of the downhole tool 24. Initially, the ROLL STOP CYCLE routine is called at 1702 to position the roll setting of the downhole tool 24. At 1704, the carriage 36 is thrust forward. At 1706, a check is made to see if the drill string 22 must be extended by the pipe handling system 20. If so, a pipe section 42 is added at 1708. After the drill string 22 has been extended, the DIRECTION CONTROL routine continues at 1706.

If the drill string 22 need not be lengthened, a check is made at 1710 to see if the carriage 36 is advancing. If the carriage 36 is not advancing, thrust is stopped at 1712 and the ROCK CYCLE routine is called at 1714. When the carriage 36 and the downhole tool 24 are advancing, checks are made to determine if the downhole tool is at a directional change point (at 1716) or if the carriage has advanced a predetermined distance, such as five feet (at 1718). If neither of these conditions are met, the DIRECTION CONTROL routine continues at 1706. If either of these checks are answered in the affirmative, the DIRECTION CONTROL routine concludes at 1720.

Roll Stop Cycle

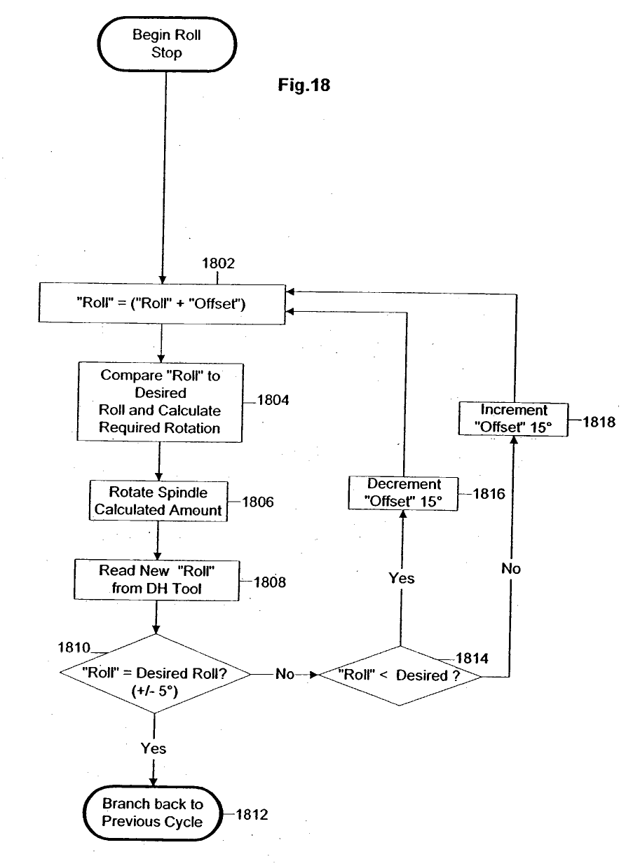

Shown in FIG. 18, the ROLL STOP CYCLE routine automatically positions the downhole tool 24 in the desired roll position as indicated for the next segment of the bore. At 1802, the roll value is obtained from the roll sensor 78 and adjusted for the offset of the drill string 22. Roll of the downhole tool 24 may not represent the same clock position as the spindle 34 because of twisting or winding that may occur in the drill string 22. The winding of the drill string can be accounted for with an offset to properly position the downhole tool 24. The actual roll position of the downhole tool 24 is compared to the desired roll at 1804. The spindle 34 is rotated the desired amount at 1806.

The new actual roll of the downhole tool 24 is obtained at 1808 and compared to the desired roll at 1810. If the actual and desired rolls are equal, the ROLL STOP CYCLE routine is completed at 1812. If the actual and desired rolls are not the same, then at 1814 the check is made to see which is greater. If the actual roll is less than the desired roll, the offset is decreased by 15° at 1816 to adjust for the wind-up in the drill string 22. If, however, the actual roll is more than the desired roll, the offset is increased by 15° at 1818 to adjust for the wind-up in the drill string 22. The ROLL STOP CYCLE routine continues at 1802 where the process is repeated until the desired roll is achieved.

Rock Cycle

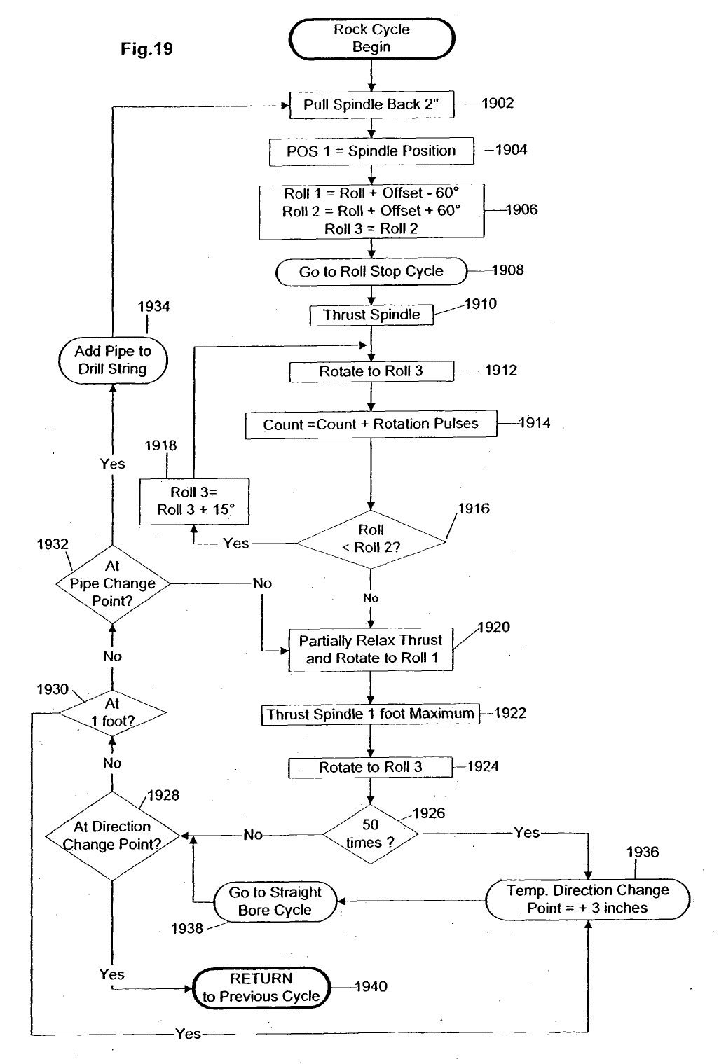

The ROCK CYCLE routine, illustrated in FIG. 19, provides the logic for controlling the movement of the drill string 22 in situations where advancing the drill string with the traditional rotation and thrust techniques has proven inadequate. The ROCK CYCLE routine may be used, for example, in hard soil or rock formations. The routine begins by relaxing the thrust at 1902. The position of the carriage 36 is recorded at 1904 and roll parameters are established at 1906. The downhole tool 24 is rotated to RollI by calling the ROLL STOP CYCLE routine at 1908. At 1910, the carriage 36 is thrust forward. The downhole tool 24 is rotated to Roll3 at 1912. At 1914, the rotation sensor pulses are counted to determine how much spindle rotation is required to move the downhole tool 24 to the desired roll. At 1916, the actual roll position of the downhole tool 24 is compared to Roll2, to see if the downhole tool has completed the full rock cycle. If the downhole tool 24 is not yet at position Roll2, then Roll3 is increased at 1918 and the process is repeated at 1912.

When the downhole tool 24 has rotated to position Roll2, the thrust on carriage 36 is partially relaxed, if necessary, and the tool rotated to its original position at 1920. If the roll position does not follow the spindle rotation, then a pipe joint may have broken loose somewhere in the drill string 22. The spindle can be rotated to tighten the loosened joint and the carriage retracted a small amount to partially relax thrust before again rotating the spindle. The carriage 36 is thrust forward at 1922. A limit, such as one foot, on the amount of advance becomes a control factor only in the event a sudden break through of the hard soil or rock formation occurs whenever downhole tool 24 is engaged with the bottom of the hole. The downhole tool 24 is then rotated to Roll3 at 1924, using the same number of rotation pulses as was determined from step 1914. The process outlined in steps 1920-1924 is repeated a predetermined number of times (between 10 and 100 times in the preferred embodiment), with the count and decision made at 1926. Preferably, the number of times steps 1920-1924 are to be repeated is identified as an input parameter to the drilling process, so that the number of rock cycles will vary depending on the type of soil that is expected to be encountered during the drilling operation.

During the rock cycle of steps 1920-1924, checks are made to determine if the downhole tool 24 is at a direction change point (at 1928) and to see if the downhole tool has advanced a limited distance such as one foot (at 1930). If neither of these conditions are met, a check is made at 1932 to see if the drill string 22 must be lengthened by the pipe handling system 20. If the drill string 22 must be extended, a pipe section is added at 1934. After the drill string 22 has been extended, the ROCK CYCLE routine is resumed again at 1902.

If the downhole tool 24 is at a direction change point (check at 1928) and has completed the desired direction change, the ROCK CYCLE routine concludes and returns to the calling routine at 1940. If, prior to reaching a direction change point either the downhole tool 24 has advanced a limited distance, such as one foot, at 1930 or if the preset repetition limit of steps 1920-1924 is reached (check at 1926), then the direction change point is incremented at 1936 and the STRAIGHT BORE CYCLE routine is called at 1938. This serves to introduce a short interval of drill string 22 and downhole tool 24 rotation to clear the downhole tool and condition the borehole.

Automatic Backream

After a drilling operation is completed, the product is installed by pulling the product back through the pilot borehole. Generally, the borehole must be cleared and enlarged for the installation of the product. This operation is referred to as the backreaming operation. Any backreamer known in the industry may be used with the present invention and is represented herein as the downhole tool 24. A backreamer suitable for use with the present invention is described in U.S. application Ser. No. 08/940,385, entitled Device and Method for Enlarging a Bore and filed Sep. 30, 1997, the contents of which are incorporated herein by reference. The utility line or product being installed underground is connected to the backreamer, generally using a swivel device. As the drill string 22 is pulled back through the pilot borehole, the backreamer and the product being installed are also pulled through the pilot borehole. For larger diameter product installations, one or more intermediate backreaming passes may be necessary before the installation pass.

During the backreaming operation, the actual location of the installed product can be identified using the tracking circuitry 58 (previously described) as the product is pulled back through the pilot borehole. The location information provided during the backreaming operation is often most advantageous to the owner of the product installed in the borehole. As with the drilling operation, the drilling system 10 can be used to automatically perform the backreaming operation.

During the backreaming operation, the guidance control circuitry 60 pulls the drill string 22 back through the pilot borehole by operating the drive system 18. With reference again to FIG. 13, the guidance control circuitry 60 operates in response to information received from the guidance control sensor group 61. The guidance control circuitry 60 monitors the status of the drive system 18 and operates the drive system to pull the drill string 22 and the downhole tool 24 at an optimum rate.

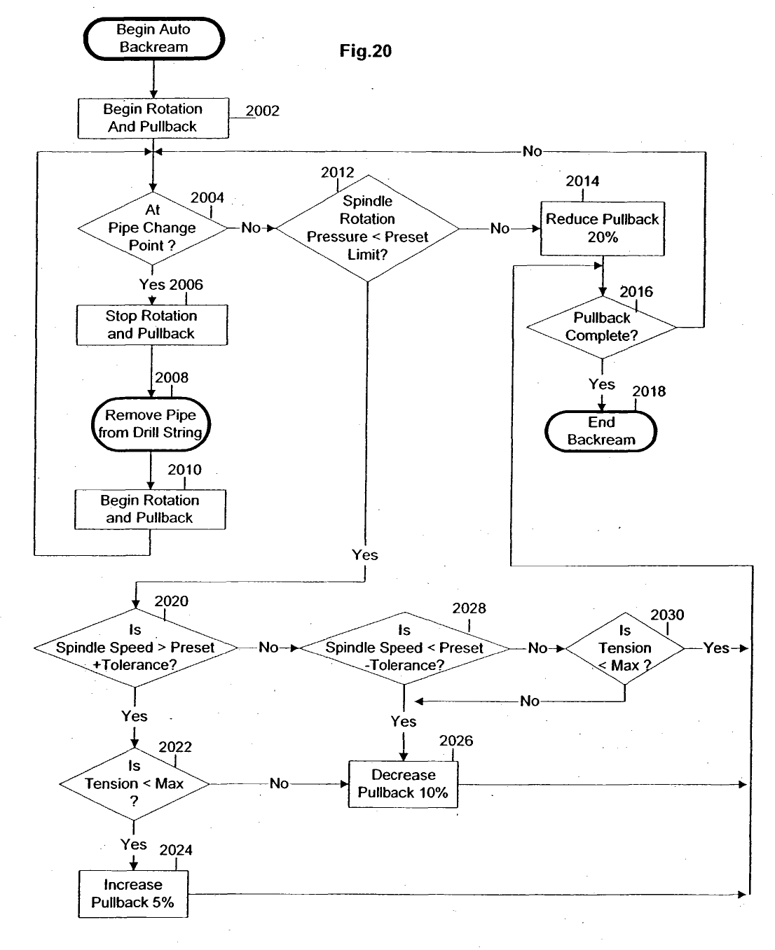

The AUTOMATIC BACKREAM routine is illustrated in FIG. 20 and shows the logic for pulling the drill string 22 back through the borehole with a product to be installed secured to the end of the drill string. Initially, the backreaming is begun at 2002 with the rotation torque and pullback set at predetermined values. Preferably, these values are determined based on the maximum tension allowed for the product to be installed, the size of the backreaming tool, and the bend radius of the drill string 22 and the product to be installed. A check is made at 2004 to determine if the carriage 36 is at the back end of its travel. If so, the pullback and rotation are stopped at 2006 and the length of the drill string 22 is reduced at 2008. In the preferred embodiment, the length is reduced by removing a pipe section 42 from the drill string 22. A suitable routine for removing a pipe section 42 and for use with the preferred embodiment is described fully in U.S. application Ser. No. 09/146,123, previously incorporated by reference. After the pipe section has been removed, the pullback and rotation are resumed at 2010 and the backreaming can continue.

If the carriage 36 is pulling back, a check is made at 2012 to determine if the spindle rotation pressure is less than the preset limit for the pressure. If the pressure is not less than the preset limit, then the pullback is reduced by a predetermined amount, such as 20%, at 2014. After the pullback is reduced, the routine checks if the backream is complete at 2016. If the backream is complete, the routine ends at 2018. If the backream is not complete, the pullback resumes at 2004.

If the spindle rotation pressure is less than the preset limit at 2012, the spindle speed is compared to the preset limit for spindle speed at 2020. If the spindle speed is greater than the preset limit by a predetermined tolerance level, then the tension on the product is checked at 2022. If the product tension is less than the maximum allowed, the pullback is increased by a predetermined amount, such as 5%, at 2024. If the product tension is not less than the maximum allowed, then the pullback is decreased by a predetermined amount, such as 10%, at 2026. After the thrust has been adjusted at 2024 or 2026, the backream continues with the check at 2016.

If the spindle speed is not greater than the preset limit by the predetermined tolerance at 2020, the spindle speed is compared to the preset limit less the predetermined tolerance at 2028. If the spindle speed is outside the tolerance range, then the pullback is decreased by a predetermined amount (10%) at 2026 and the backream can continue at 2016. If the spindle speed is within tolerance at 2028, then the tension of the product is checked at 2030. If the tension is not less than the maximum allowable for the product, then the pullback is decreased by a predetermined amount (10%) at 2026. If the tension is less than the maximum allowable, the AUTOMATIC BACKREAM routine continues at 2016.

Drilling and Backreaming a Borehole

In accordance with a method of drilling and backreaming a horizontal borehole using a drilling system as herein described, a selected bore path is first identified. The selected bore path will have a beginning point and an ending point. As previously described, the selected bore path will preferably represent a segment of the drilling operation.

The drilling begins when the downhole tool of the drilling machine is positioned at the beginning point of the selected bore path. The drilling system then automatically advances the downhole tool along the selected bore path. During the drilling operation, the drilling system engages the power management system, the fluid control system, the pipe handling system, the tracking system, and the guidance control system which may all operate simultaneously.

Initially, the guidance control circuitry advances the downhole tool in a straight line. The tracking circuitry monitors the location and orientation of the downhole tool, communicating the information to the main control circuit. The information received from the tracking circuitry is documented to record the path of the borehole as it is being bored. The location and orientation of the downhole tool can then be compared to the selected bore path. When the downhole tool veers from the selected bore path or as the selected bore path calls for a change in direction, the guidance control circuitry will operate to change the direction of the downhole tool, guiding the downhole tool along or back to the selected bore path.

As the drilling progresses, the pipe handling system operates to lengthen the drill string as it needs to be extended. In the preferred embodiment, the guidance control circuitry stops the rotation and thrust of the drill string while a pipe section is added to the drill string. Also, the fluid control system will stop fluid flow while the pipe handling system is adding a pipe section. Generally, the fluid control system will operate to continuously pump fluid through the drill string, except when the drill string is being lengthened or shortened. The power management system also operates continuously during the drilling operation, controlling the output of the engine in response to power requirements.

When the drilling operation is completed, and the downhole tool is at the ending point of the selected bore path for the drilling operation, a backreaming operation is commenced to install a utility line or product in the borehole. For the backreaming operation, the downhole tool is preferably a backreamer. The utility line or product to be installed underground is attached to the backreamer, preferably using a swivel mechanism. As the drill string and downhole tool are pulled back through the borehole, the utility line will be installed in the borehole.

The guidance control system controls the rotation and pullback of the drill string through the borehole, while monitoring the tension on the utility line or product being installed. As the downhole tool is pulled back through the borehole, the tracking system monitors the location and orientation of the downhole tool. Using that information, the installed location of the utility line can be documented.

The operation of the fluid control system and the power management system is essentially the same during the backreaming operation as during the drilling operation. The pipe handling system is also used during the backreaming operation, where the drill string needs to be shortened. When a pipe section is to be removed from the drill string during the backreaming operation, rotation and pullback of the drill string and the flow of fluid are stopped.

Those skilled in the art will appreciate that variations from the specific embodiments disclosed above are contemplated by the invention. The invention should not be restricted to the above embodiments and is capable of modifications, rearrangements, and substitutions of parts and elements without departing from the spirit and scope of the invention.

What is claimed is:

1. A method for installing a utility line in a borehole comprising:
drilling a pilot borehole; and
automatically backreaming the pilot borehole while installing a utility line.

2. The method of claim 18 further comprising attaching the utility line to a backreamer.

3. The method of claim 19 further comprising recording the actual location of the utility line installed underground as the utility line is automatically pulled through the borehole.

4. A method for backreaming a horizontal borehole, the method comprising:
automatically pulling a drill string through the horizontal borehole;
automatically reducing a length of the drill string when the drill string must be shortened;
automatically reducing a rate of pullback if the rotation pressure on the drill string is greater than a predetermined limit; and
automatically reducing a rate of pullback if the product tension is greater than a predetermined limit.
